(19) United States
(12) Patent Application Publication
(10) Pub. No.: US 2011/0289302 A1
(43) Pub. Date: Nov. 24, 2011

(54) DATA PROCESSING DEVICE AND METHOD

(75) Inventors: Atsushi UBUKATA, Kyoto (JP); Osamu KAWAMURA, Osaka (JP); Masataka OSAKA, Osaka (JP)

(73) Assignee: PANASONIC CORPORATION, Osaka (JP)

(21) Appl. No.: 13/198,127

(22) Filed: Aug. 4, 2011

Related U.S. Application Data
(63) Continuation of application No. PCT/JP2009/006506, filed on Dec. 1, 2009.

(30) Foreign Application Priority Data
Feb. 24, 2009 (JP) 2009-041558

(51) Int. Cl. G06F 9/30

(52) U.S. Cl. 712/227; 712/E09.016

(57) ABSTRACT

Overhead is significant when a timestamp according to a reference time is inserted. In view of this, there is provided an LSI which includes: a first time information conversion unit which converts, into time information of a reference time, time information from a first trace data source; a second time information conversion unit which converts, into time information of a reference time, time information from a second trace data source; and a packet merging unit.

### CROSS REFERENCE TO RELATED APPLICATION

This is a continuation application of PCT application No. PCT/JP2009/006506 filed on Dec. 1, 2009, designating the United States of America.

### BACKGROUND OF THE INVENTION

(1) Field of the Invention

The present invention relates to a data processing device which, in an information processing apparatus having plural trace data sources, is capable of providing a temporal correlation between the trace data sources.

(2) Description of the Related Art

In a large-scale system LSI (Large Scale Integration), a single LSI includes plural processor cores (processing devices), and these perform desired operations while being interrelated. Therefore, in performing system level debugging of such system LSIs, it is necessary to know the temporal context, that is, the temporal correlation arising between plural cores.

Conventionally, a reference timestamp generator is provided, and, at the timing at which the reference timestamp is generated, a reference timestamp is inserted in each trace data source or a packet associated with a reference timestamp packet is generated. These enable the mutual temporal relationship of the trace data sources to be analyzed (see Patent Reference 1: Japanese Unexamined Patent Application Publication No. 2005-56380).

### SUMMARY OF THE INVENTION

However, in an actual system, each of the trace data sources needs to have a function that enables outputting of trace data having a time information item even by itself. As such, the time information item according to respective local clocks is added to the original trace packet in the form of a difference time, and the trace packet to which the time information item has been added is outputted.

Since a packet which denotes the reference timestamp is also outputted in addition to such local timestamp information item, there is the problem that the overhead attributed to the information items for obtaining the temporal correlation increases.

Furthermore, in outputting the trace streams of plural cores, the bandwidth allocated for trace outputting is insufficient compared to the bandwidth required for outputting. As such, a First-In, First-Out (FIFO) overflow occurs in the trace buffer and loss of packets occurs. As a countermeasure, in order to filter more important trace information items, priority control is performed according to the trace data source and packet details, and a packet having a lower priority is discarded.

As a result, the respective difference time information items accompanying the packets of each of the trace data sources is lost, and the time information item is lost until the appearance of a subsequent synchronizing packet, and thus there is the problem that it is not possible to perform an operation analysis having a temporal correlation between plural cores (analysis based on temporal correlation is not possible).

The present invention has as an object to obtain the correlation between time information items of different trace data sources, while avoiding the negative effects caused by outputting even a reference timestamp in addition to local time information.

In order to solve the aforementioned problems, the data processing apparatus according to an aspect of the present invention includes: a first trace data source; a first time information conversion unit configured to convert, into a time information item of a reference time, each of a plurality of time information items that accompanies a corresponding one of a plurality of trace packets from the first trace data source; a second trace data source; a second time information conversion unit configured to convert, into a time information item of a reference time, each of a plurality of time information items that accompanies a corresponding one of a plurality of trace packets from the second trace data source; and a packet merging unit configured to receive the trace packets having the corresponding time information item converted by the first time information conversion unit and the trace packets having the corresponding time information item converted by the second time information conversion unit, to select and output the trace packet having an earliest one of the time information items, and to remove a redundant time information item among the time information items of the trace packets.

It should be noted that selecting and outputting the trace packet having an earliest one of the time information items means selecting, from among the received trace packets, the trace packet that is accompanied by the earliest time information item among the time information items accompanying the trace packets, and outputting the selected trace packet.

Furthermore, a redundant time information item among the time information items of the trace packets means time information indicating the same time as the time indicated by a time information item other than such time information item, which is included among the respective time information items of the trace packets.

In addition, each of the time information conversion units may convert, into a time information item of a single reference time, a time information item of the trace data source corresponding to the time conversion unit. Here, a time information item of a single reference time means being, as a consequence of a time information item of the reference time, a time information item belonging to a single (common) type as another time information item, resulting from the conversion by the other time information conversion unit, which is likewise a time information item of the reference time. Here, the other time information conversion unit is a time information conversion unit that is different from the time information conversion unit that performed the conversion of such time information item.

In addition, each of the time information items of the respective trace data sources may be an elapsed time indicating an elapsed time (difference) from a predetermined specific time.

Conventionally, time information items such as a local timestamp and a reference time stamp are outputted. However, according to the present invention, only timestamp information items according to a single reference clock are outputted. This reduces the overhead of the trace data obtained at the end.

In addition, although, conventionally, the packets required for synchronization remain in the final trace data, according to the present invention, overhead is further reduced by removing the synchronization packets required for inter-packet synchronization.

Furthermore, conventionally, when the time information items from the trace data sources are difference time information items and part of the trace packets is lost, the time information items up to the next synchronization timing are lost. However, according to the present invention, the respective time information items of the remaining trace packets are not lost, and thus it is possible to obtain information regarding the temporal correlation between the trace data sources.

### FURTHER INFORMATION ABOUT TECHNICAL BACKGROUND TO THIS APPLICATION

The disclosure of Japanese Patent Application No. 2009-041558 filed on Feb. 24, 2009, including specification, drawings and claims is incorporated herein by reference in its entirety.

The disclosure of PCT application No. PCT/JP2009/006506 filed on Dec. 1, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 illustrates a configuration in which packet merging is performed after time information items of trace data sources of plural cores are converted;

FIG. 2 illustrates a configuration in which a synchronization packet request is provided to each of the trace data sources;

FIG. 3 illustrates a configuration in which time information items of packets are re-converted into difference times, in the output of the packet merging;

FIG. 4 illustrates how trace information of the respective trace data sources are processed and converted into one trace stream, through the configuration in FIG. 1;

FIG. 5 illustrates how trace information of the respective trace data sources are processed and converted into one trace stream, through the configuration in FIG. 2;

FIG. 6 illustrates, particularly in the case where each time information item of the trace information items of the respective trace data sources are given as difference times, how such time information items are converted, through the configuration in FIG. 1 and FIG. 2;

FIG. 7 illustrates an example in which the time information items of the packet merging output are converted to difference times through the configuration in FIG. 3; and

FIG. 8 illustrates that time information items are held correctly through the configuration in FIG. 3, even when part of the packets of the trace data sources are lost.

### DESCRIPTION OF THE PREFERRED EMBODIMENT(S)

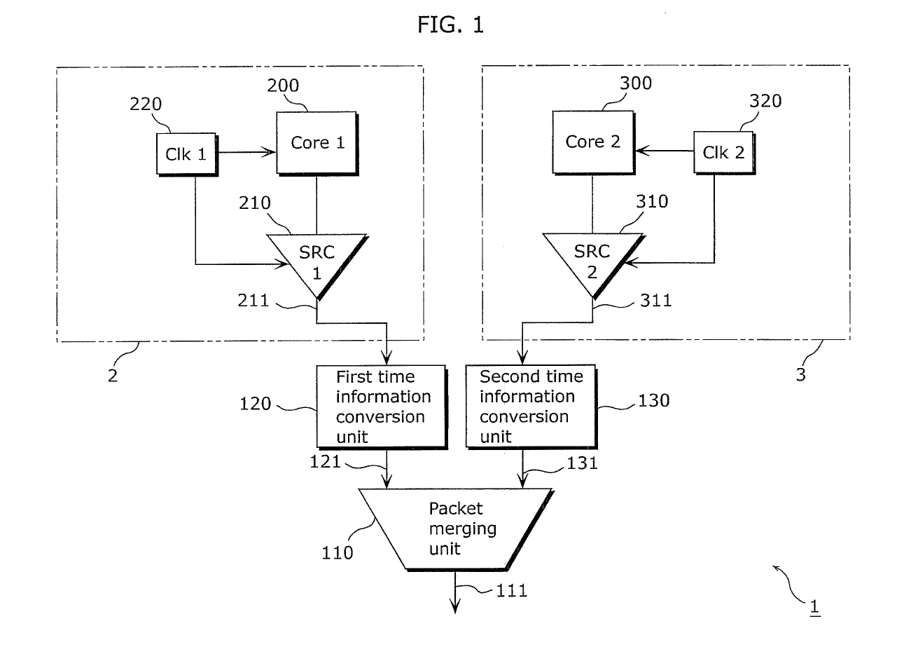

In Embodiments 1 to 4, first, conversion units (first time information conversion unit 120, second time information conversion unit 130) are provided which convert, into an elapsed time of a reference time, each of time information items (first time information item, second time information item) of local clocks (first local clock 220, second local clock 320 (FIG. 1 and so on)), included in trace packets from the respective trace data sources. Next, a packet merging unit (packet merging unit 110) is provided which sorts, focusing on time information items, trace data (first converted trace packets 121, second converted trace packets 131) having the time information item that has been converted into reference time, removes an unnecessary time information item that overlaps with another time information item, and selectively outputs the trace packets of the trace data sources (first trace data source 210, second trace data source 310). This reduces the overhead for obtaining the temporal correlation.

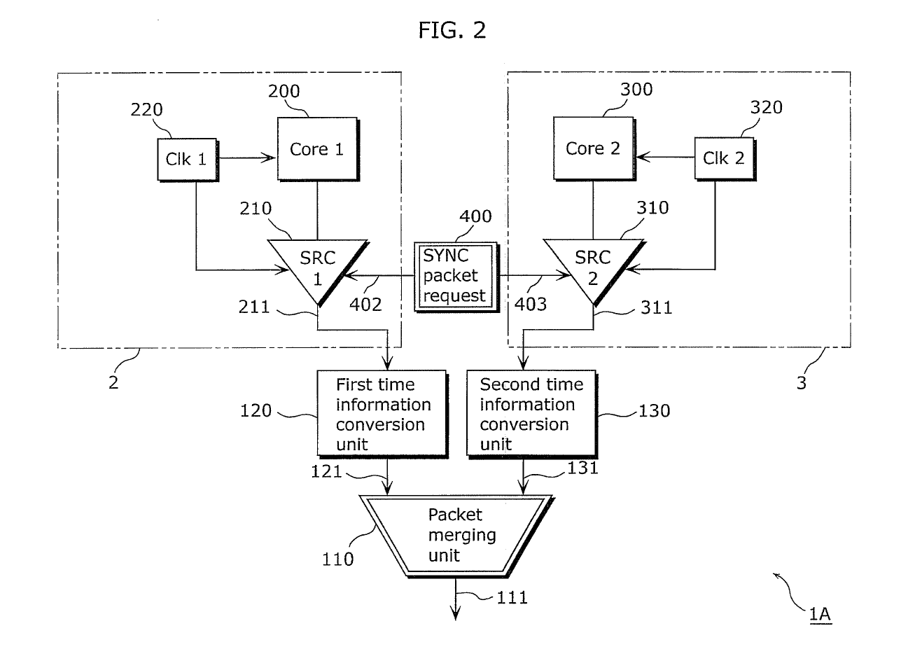

In addition, a synchronization packet request unit (synchronization packet requesting unit 400 (FIG. 2)) which causes a trace data source to generate a synchronization packet is provided, and the respective trace data sources are caused to generate synchronization packets. Then, after the generated synchronization packets are used by the packet merging unit (packet merging unit 110) for packet output synchronization, such synchronization packets are removed by the packet merging unit 110. With this, overhead is reduced.

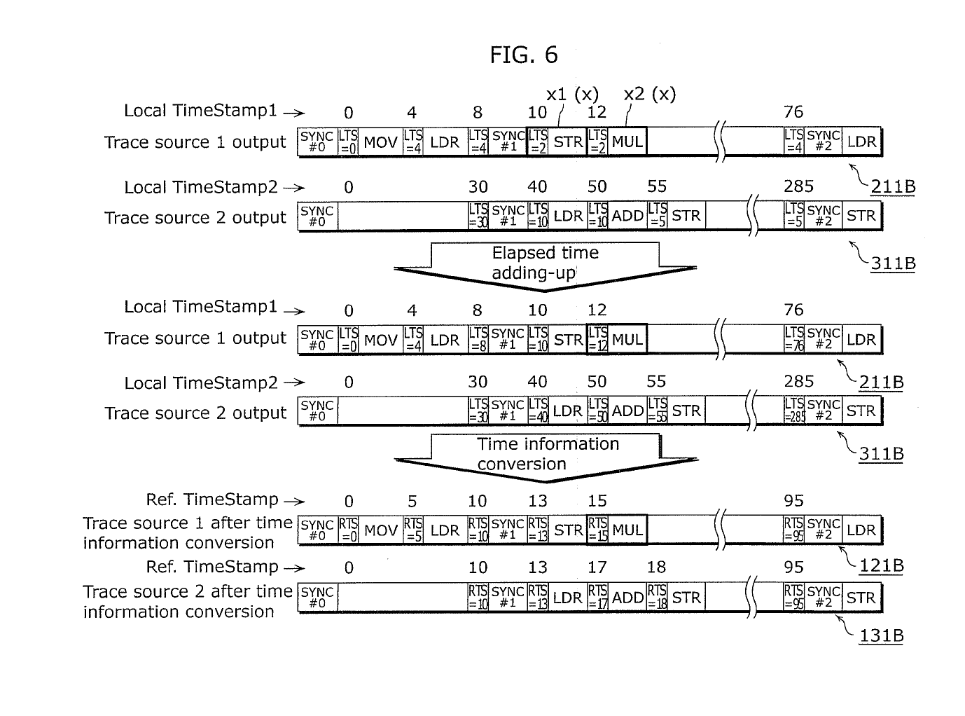

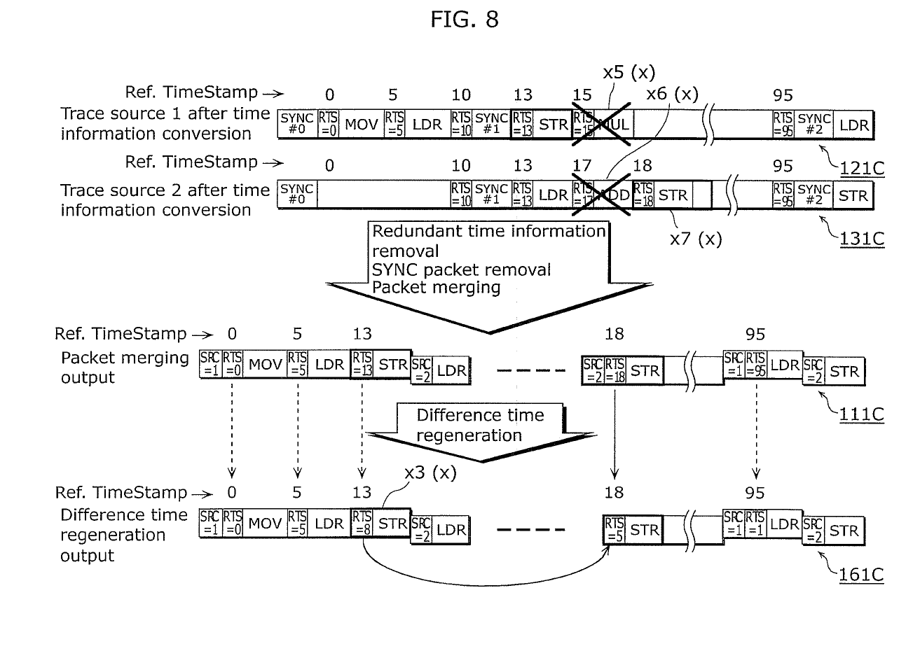

Furthermore, even when the respective time information items accompanying the trace packets outputted by the respective trace data sources are the difference times according to the corresponding local clocks (time information item of a first source stream 211B and time information item of a second source stream 311B, in the top stage in FIG. 6), these are added-up by the respective time information conversion units. Subsequently, each of the added-up times is converted by the respective time information conversion units into an elapsed time (time information item of the first source stream 211B and time information item of the second source stream 311B, in the middle stage in FIG. 6). Then, the elapsed times resulting from the conversions are converted by the respective time information conversion units into time information items of a reference clock (time information item of the first source stream 211B and time information item of the second source stream 311B, in the bottom stage in FIG. 6). With this, even when a packet is discarded by the packet merging unit (see packet x5 and packet x6 in FIG. 8), the elapsed times of the remaining trace packets (the remaining trace packets other than the trace packet that has been disregarded) are not lost (see second trace stream 161C in FIG. 8), and thus the temporal correlation between the trace data sources can be obtained.

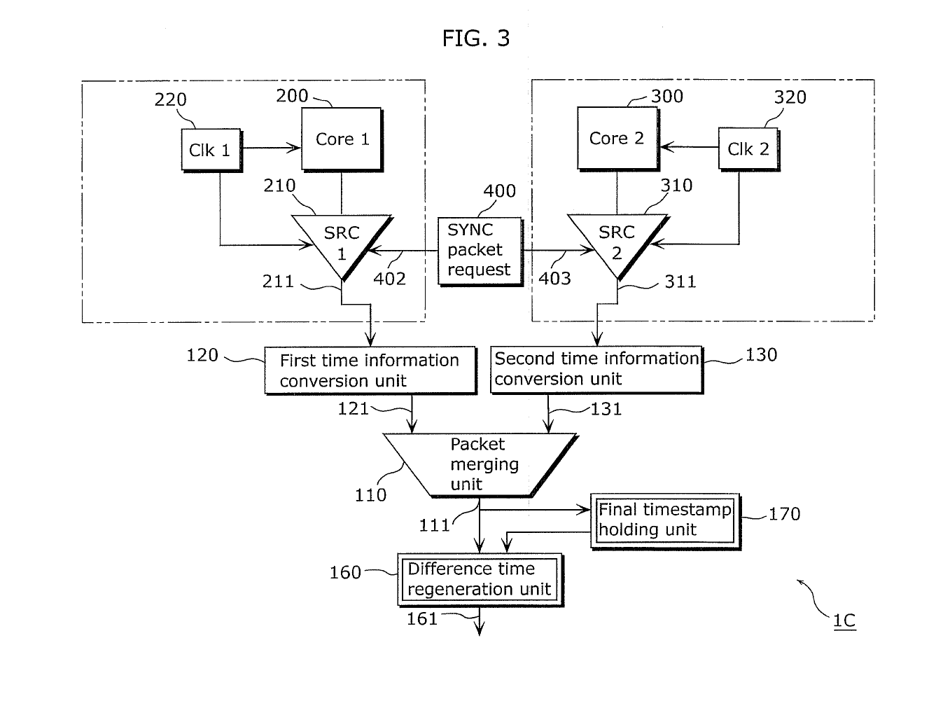

In addition, a difference time regeneration unit (difference time regeneration unit 160 (FIG. 3 and so on)) is provided which calculates the difference between the time information item included in the trace packet obtained after the packet merging and the time information item (timestamp) of the last outputted packet, and the data amount for the timestamp output is reduced through the conversion of the time information item into a difference time performed by the difference time regeneration unit.

Detailed description follows.

### Embodiment 1

FIG. 1 is a diagram showing a configuration of an LSI 1 in Embodiment 1.

FIG. 1 illustrates the configuration of the LSI 1 which performs packet merging after converting the time information items of trace data sources of plural cores.

Here, the first trace data source 210 operates according to the first local clock 220, and outputs trace information items (first trace information items) from a first processor core 200 together with time information items (first time information items) measured according to the first local clock 220. The second trace data source 310 operates according to the second local clock 320, and outputs trace information items (second trace information items) from a second processor core 300 together with time information items (second time information items) measured according to the second local clock 320.

The first trace packet (trace information item) 211 from the first trace data source 210 is inputted to the packet merging unit 110 after the first time information item accompanying the first trace data source 210 is converted by the first time information conversion unit 120 into time a information item of a reference time. In the same manner, the second trace packet (trace information item) 311 from the second trace data source 310 is inputted to the packet merging unit 110 after the second time information accompanying the second trace data source 310 is converted by the second time information conversion unit 130 into a time information item of a reference time.

The packet merging unit 110 sorts trace information items accompanied by respective time information items of the same reference time using the respective time information items (time information items of the reference time) as a key, and, after removing redundant time information items, reconciles/selects the trace information items (trace packets) from each of the trace data sources (first trace data source 210, second trace data source 310), and outputs reconciled/selected trace information items (trace stream 111).

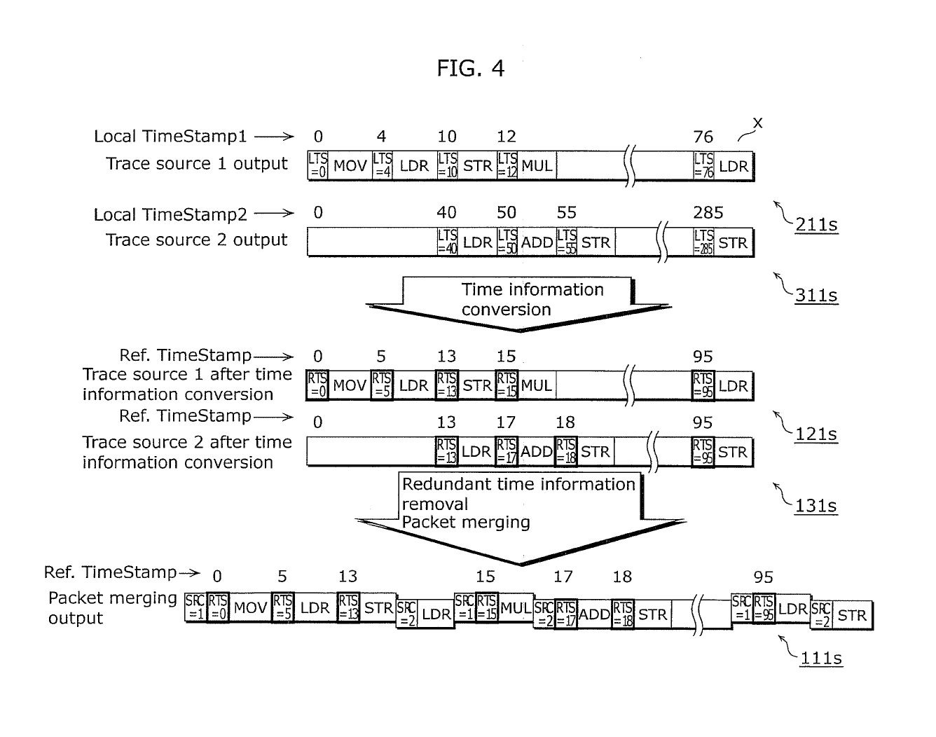

FIG. 4 is a diagram showing respective streams in Embodiment 1.

FIG. 4 illustrates how the trace information items from the respective trace data sources are processed and converted into one trace stream (trace stream 111s), through the configuration in FIG. 1.

This example shows that, for the output (first source stream 211s) of the first trace data source 210 (FIG. 1), a “MOV” command is executed by the first processor core 200 at a time 0 according to the local timestamp. Then, it is shown that a “LDR” command is executed by the first processor core 200 at a time 4, a “STR” command at a time 10, a “MUL” command at a time 12, and a “LDR” command at a time 76.

It should be noted that the local timestamp is denoted by “LTS=”. Specifically, a time affixed with the characters LTS is a time according to the local timestamp. It should be noted that, as described in detail later, a time affixed with the characters RTS is a time according to the reference timestamp.

In the same manner, it is shown that, for the output (second source stream 311s (FIG. 4)) of the second trace data source 310, the “LDR” command is executed by the second processor core 300 at a time 40, a “ADD” command at a time 50, and “STR” commands at times 55 and 285, according to the local timestamps.

These two outputs (the first source stream 211s, the second source stream 311s) are converted into converted data items (first converted trace stream 121s, second converted trace stream 131s) by the first time information conversion unit 120 and the second time information conversion unit 130, respectively. Specifically, the first time information items and the second time information items of the respective trace packets of the above-described two outputs are converted into time information items of a reference timestamp (time information items of a reference time) by the first time information conversion unit 120 and the second time information conversion unit 130, respectively.

For example, local timestamps LTS=10 and LTS=76 of the output (the first source stream 211s) of the first trace data source 210 shown in FIG. 4 are converted into RTS=13 and RTS=95, respectively, according to the reference time (see first converted trace stream 121s). Furthermore, for the local timestamps (second time information items) of the second trace data source 310 (FIG. 1), LTS=4 and LTS=55 are converted into RTS=13 and RTS=18, respectively, according to a different rule, as shown in FIG. 4. These conversions are performed through calculation or conversion according to a clock ratio between the local clock and the clock for the reference timestamps for example.

In addition, in the final packet merge output (trace stream 111s), after the redundant time information items after the conversion of the two time information items are removed by the packet merging unit 110, identification packets of the two trace data sources are attached to the trace stream 111s by the packet merging unit 110, the respective packets are arranged in order of occurrence and put together as one trace data, and the trace stream ills in which the respective packets are put together is outputted. With regard to RTS=13 and RTS=95 which are times common to the first and second trace data sources, their time information items are put together as one since they overlap.

Specifically, the first local clock 220 specifies a first time by outputting a clock. For example, the first time is specified by the number of clocks outputted from a predetermined time, such as the activation time of a first execution unit 2 (FIG. 1), up to the present.

The first processor core 200 executes, for example, the processing of a command included in a program in a machine language, and outputs a trace information item that includes a process specifying information item for specifying the executed processing. It should be noted that the trace information item may be composed of only the process specifying information item. The first trace data source 210 (i) generates a first time information item for specifying a first time at which the processing in the process specifying information item outputted by the first processor core 200 is executed by the first processor core 200, and (ii) outputs the generated first time information item. Here, the outputted first time information item is outputted by the first trace data source 210 as an information item accompanying the process specifying information item of the processing executed at the first time indicated by such first time information item. The first processor core 200 generates, for example, a trace information item (the first trace packet 211 (FIG. 1)) in which the process specifying information and the generated first time information item are included, and outputs the generated trace information item.

The first time information conversion unit 120 (FIG. 1) converts, into a time information item of the reference time, the first time information item included in the first trace packet 211 outputted by the first trace data source 210. It should be noted that the reference time is, for example, an actual objective time. It should be noted that the reference time indicated by the time information item of the reference time after conversion is the same as the reference time at which the processing in the process specifying information item accompanied by the first time prior to the conversion is executed.

Subsequently, the first processor core 200 executes, for example, the plural commands included in the program in a machine language, and outputs process specifying information items. The first processor core 200 outputs a first processor stream (not illustrated) including the respective first trace packets 211 of the process specifying information items.

A first trace packet x shown in FIG. 4 is one (an example) among the plural first trace packets 211 included in the first source stream 211s outputted by the first trace data source 210. The first trace packet x includes, for example, a process specifying information item for specifying a machine language command “LDR” and a first time information item (LTS=76) for specifying the first time “76”, as shown in FIG. 4. It should be noted that, in this manner, a time information item accompanying a process specifying information item may, together with such process specifying information item, configure one packet.

Then, the first time information conversion unit 120 converts, into a time information item of the reference time, each of the first time information items (“76” and so on) of the respective first trace packets such as the first trace packet x included in the first source stream 211s (FIG. 4).

A second execution unit 3 (FIG. 1) and the second time information conversion unit 130 (FIG. 1) have a configuration that corresponds to the first execution unit 2 and the first time information conversion unit 120, respectively.

It should be noted that the local clock (second local clock 320) which specifies a second time is different from the first local clock 220. Specifically, the second time may be, for example, a time having a time difference with the first time or a time that advances at a different speed from the speed at which the first time advances.

The packet merging unit 110 receives, as input, the first converted trace stream 121s (FIG. 4) outputted by the first time information conversion unit 120 and the second converted trace stream 131s outputted by the second time information conversion unit 130. With this, the packet merging unit 110 receives, as input, the plural first converted trace packets 121 included in the first converted trace stream 121s and the plural second converted trace packets 131 included in the second converted trace stream 131s. Hereinafter, the set of trace packets composed of all the plural first converted trace packets 121 and the plural second converted trace packets 131 shall be referred to as a converted trace packet set.

Subsequently, the packet merging unit 110 generates the trace stream 111s (FIG. 4) in which the respective trace packets included in the converted trace packet set are included, and outputs the generated trace stream 111s. The trace stream 111s that is generated and outputted includes, for example, any of the trace packets included in the converted trace packet set. In addition, the order of each trace packet among the respective trace packets of the trace stream 111s is the same as the order of the time information item of the reference time of such trace packet, among the respective time information items of the reference time of the respective trace packets.

Then, in the following case, the packet merging unit 110 generates the trace stream 111s in which only the time information items of one out of two reference times is included. Specifically, in this case, out of the time information items of one and the other of two reference times, the packet merging unit 110 removes the time information items of the other of the reference times. In addition, the case where such removing occurs is the case where a second converted trace packet 131 (FIG. 1), which has the same time information item of the reference time as the time information item of the reference time of a first converted trace packet 121 (FIG. 1) included in the first converted trace stream 121s (first row in the middle stage in FIG. 4), is included in the second converted trace stream 131s. In this case, one of the time information items is left and the other is removed.

Specifically, for example, in the example in FIG. 4, the time information item “13” (RTS=13) of the third reference time from the left in the first converted trace stream 121s is the same as the time information item “13” of the left-most reference time in the second converted trace stream 131s. With this, the packet merging unit 110 removes the time information item (RTS=13) of the reference time of the left-most converted trace packet of the second converted trace stream 131s. It should be noted that the generated trace stream 111s, for example, specifies the reference time of the converted trace packet (the left-most second converted trace stream 131s of the second converted trace stream 131s) that was removed, using the time information item of the reference time of the converted trace packet (the third converted trace packet from the left of the first converted trace stream 121s in FIG. 4) that was not removed.

Furthermore, the packet merging unit 110 adds an identification packet (SRC=1 and so on) in each of the positions of one or more converted trace packets (for example, the position of the left-most converted trace packet of the trace stream 111s in FIG. 4). The added identification packet identifies the trace data source of the converted trace packet in such position, from among the plural trace data sources. Specifically, the identification packet is data for identifying out of the first trace data source 210 and the second trace data source 310, the original trace data source (the first trace data source 210) which outputted the trace packet prior to conversion (for example the left-most trace packet of the first source stream 211s) which is the origin of the converted trace packet at the position in which the identification packet is added.

### Embodiment 2

FIG. 2 is a diagram showing a configuration of an LSI 1A in Embodiment 2.

FIG. 2 shows the configuration of Embodiment 2, and shows that, in addition to the configuration in FIG. 1, a synchronization packet requesting unit 400 inputs synchronization packet requests (request signal 402, request signal 403) to each of the trace data sources.

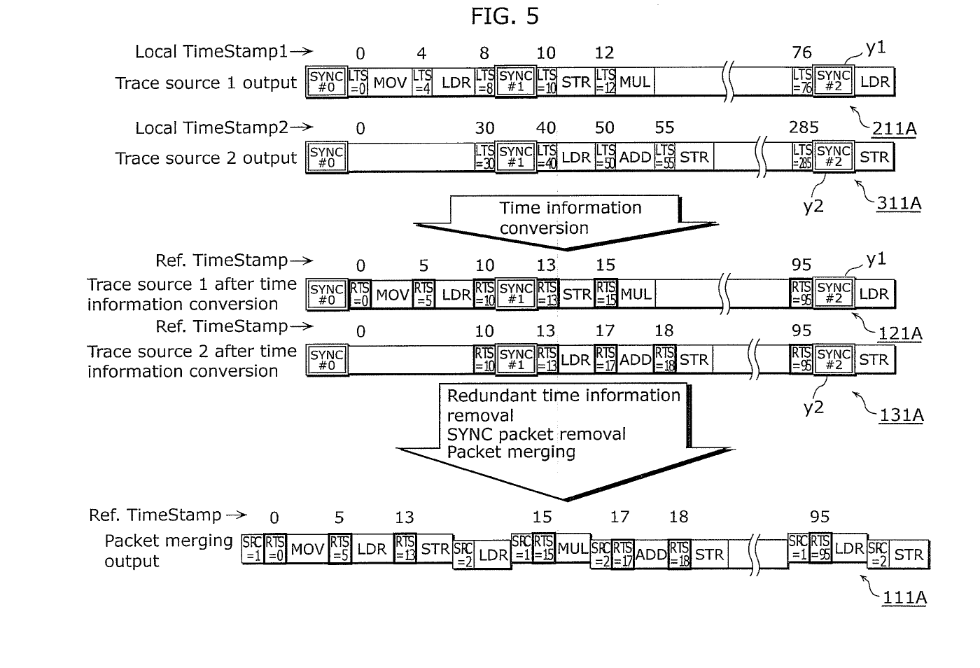

The synchronization packet requesting unit 400 which requests the generation of a synchronization packet (see synchronization packet y1 and so on in FIG. 5) to the respective trace data sources (the first trace data source 210 and the second trace data source 310) is further added to the LSI 1 in Embodiment 1. Then, upon being requested for a synchronization packet by the synchronization packet requesting unit 400, each of the first trace data source 210 and second trace data source 310 inserts a synchronization packet into the trace data (first source stream 211A and so on in FIG. 5) to be outputted by such trace data source.

As described earlier, the trace streams (trace data) 211A and 311A (FIG. 5) from the respective trace data sources are inputted to the packet merging unit 110 after the time information items of the respective local clocks are converted into the time information items of the reference time by the first time information conversion unit 120 and second time information conversion unit 130 (FIG. 2), respectively.

The packet merging unit 110 sorts the trace information items (converted trace packets) accompanied by time information items of the same reference times using the synchronization packets and the time information as keys, and, after removing redundant time information items, reconciles/selects the trace information items (converted trace packets) from each of the trace data sources, and outputs the reconciled/selected trace information items.

FIG. 5 is a diagram showing respective streams to be processed by the LSI 1A in Embodiment 2.

FIG. 5 illustrates how the trace information items (the first source stream 211A and the second source stream 311A) from the respective trace data sources are processed and converted into one trace stream (the trace stream 111s), through the configuration in FIG. 2.

The example in FIG. 5 shows that, for the output (first source stream 211A) of the first trace data source 210 (FIG. 2), a “MOV” command is executed at a time 0, a “LDR” command is executed at a time 4, a “STR” command is executed at a time 10, a “MUL” command is executed at a time 12, and a “LDR” command is executed at a time 76, according to the local timestamps (the first time). Furthermore, there are respective synchronization packet requests at the times 0, 8, and 76, and thus synchronization packets “SYNC” (synchronization packet y1 at time 76, and so on) are outputted. It should be noted that the local timestamp is denoted by “LTS=”. In the same manner, it is shown that, for the output (second source stream 311A (FIG. 5)) of the second trace data source 310, a “LDR” command is executed at a time 40, a “ADD” command is executed at a time 50, and “STR” commands are executed at times 55 and 285, according to the local timestamps (the second time). Furthermore, there are respective synchronization packet requests at the times 0, 30, and 285, and thus synchronization packets “SYNC” are outputted.

It should be noted that the synchronization packet requesting unit 400 issues a synchronization packet request to the first trace data source 210 and also issues, simultaneously, a synchronization packet request to the second trace data source 310. Specifically, for example, each of the times 0, 30, and 285 of the above-mentioned second time is a time converted by the second time information conversion unit 130 into respective reference times that are the same as the respective reference times into which the above-mentioned times 0, 48, and 76 of the first time have been converted by the first time information conversion unit 120.

These two outputs are converted by the time information conversion units (the first time information conversion unit 120 and the second time information conversion unit 130) into a first converted trace stream 121A and a second converted trace stream 131A (FIG. 5), respectively. Specifically, the respective time information items of the trace packets of the respective streams prior to conversion are converted into reference timestamps (time information items of the reference time). For example, local timestamps LTS=10 and LTS=76 of the first trace data source 210 (see first source stream 211A) are converted into RTS=13 and RTS=95, respectively, according to the reference time (see first converted trace stream 121A). In the same manner, for example, for the local timestamps LTS=4 and LTS=55 of the second trace data source 310 are converted into RTS=13 and RTS=18, respectively, according to a different conversion rule. These conversion processes are performed through calculation or conversion according to a clock ratio between the local clock and the clock of the reference timestamps for example.

In addition, in the final packet-merging output (trace stream 111A), the packet merging unit 110 (FIG. 2) correctly rearranges the temporal context between the trace information items (converted trace packets), according to the synchronization packets “SYNC” (sorts the order of the converted trace packets according to the order of the time information items of the reference times). Furthermore, in the final packet-merging output (trace stream 111A), the packet merging unit 110 removes the redundant time information item after the conversion of the two time information items and removes the synchronization packets “SYNC”. Subsequently, the packet merging unit 110 attaches the identification packets of output of the two trace data sources to the trace stream 111A, puts together the plural packets as one trace data, and outputs the trace stream 111A in which the packets are put together.

Specifically, upon receiving a synchronization packet request from the synchronization packet requesting unit 400, the first trace data source 210 inserts a first synchronization packet y1 (FIG. 5) into the first source stream 211A to be outputted. When a trace packet included in the first source stream 211A has an order that is ahead of the order of the inserted first synchronization packet y1, such trace packet has a first time information item of a first time that is ahead of a first time of the synchronization packet request of the synchronization packet y1. Furthermore, when the trace packet has an order that is equal to or after the order of the first synchronization packet y1, such trace packet has a first time of a first time that is equal to or after the first time of the synchronization packet request.

The packet merging unit 110 generates the trace steam 111A (FIG. 5) based on the first synchronization packet y1 and a second synchronization packet y2 (see FIG. 5) resulting from the synchronization packet request to the second trace data source 310 which is issued at the same time as the synchronization packet request according to which the first synchronization packet y1 is inserted. Specifically, the packet merging unit 110 simply and rapidly identifies, among respective packets of the first converted trace stream 121A, the property of the time information item of each preceding-order trace packets whose order precedes that of the synchronization packet y1. Here, the identified property is, for example, all of such trace packets having a time information item of a reference time that is earlier than each subsequent-order trace packet whose order is subsequent to the synchronization packet y2, among respective trace packets of the second source stream 311A. With this, the packet merging unit 110 generates, simply and rapidly, the trace stream 111A in which the order of each of the trace packets included therein is the same as the order of the time information item of such trace packet.

Specifically, based on the synchronization packet (for example, the SYNC #1 packet in the first converted trace stream 121A) included in the converted trace stream (for example, the first converted trace stream 121A), the packet merging unit 110 simply and rapidly identifies, among the respective packets included in such converted trace stream, (i) each packet in a position ahead of the position (the position of RTS=13) corresponding to the synchronization packet in the trace stream 111A and (ii) each packet in a position after such position (the position of RTS=13). It should be noted that, here, the identified respective packets in a position preceding such position (the position of RTS=13) are the respective packets that are ahead of the synchronization packet in the converted trace stream. Furthermore, the identified respective packets in a position that is subsequent to such position (the position of RTS=13) are the respective packets subsequent to the synchronization packet in the converted trace stream. In addition, the position corresponding to the synchronization packet (for example, the synchronization packet y1) in the trace stream 111A is the same position (position of RTS=95) as the position corresponding to the synchronization packet (the synchronization packet y2) that is simultaneous with such packet (the synchronization packet y1).

Furthermore, the packet merging unit 110 outputs the trace steam 111A (see FIG. 5) in which the first synchronization packet y1 and the second synchronization packet y2 are not included. Stated differently, the packet merging unit 110 removes the first synchronization packet y1 and the second synchronization packet y2.

It should be noted that, based on identification data, which is included in at least one of the first synchronization packet y1 and the second synchronization packet y2 (for example, the synchronization packet y1), for identifying the other of the synchronization packets (the synchronization packet y2), the packet merging unit 110 may identify the packet that is identified by the identification data, as the aforementioned other synchronization packet (the synchronization packet y2).

### Embodiment 3

FIG. 6 is a diagram showing respective streams in Embodiment 3.

The examples in Embodiments 1 and 2 describe the case where, in the respective trace data sources, the local timestamps (the first time information item and the second time information item) are provided as elapsed times. In contrast, the local timestamp may be the difference time from a time measured using a local clock (see LTS value of first source stream 211B, and so on, in the top stage in FIG. 6).

When the time information items of the trace information items of the trace data source are provided as difference times, each of the first time information conversion unit 120 and the second time information conversion unit 130 adds up the present difference time and the respective past different times, and converts the present difference time into an elapsed time. After performing such conversion, each of the first time information conversion unit 120 and the second time information conversion unit 130 converts the elapsed time after the conversion into a reference time (see RTS value in first converted trace stream 121B, and so on, in the bottom stage in FIG. 6).

The appearance of the trace packet conversion in the above-described case is shown in FIG. 6.

Each of the process of converting from the first source stream 211B in the top stage in FIG. 6 to the first source stream 211B in the middle stage, and the process of converting from the second source stream 311B in the top stage to the second source stream 311B in the middle stage is a process of converting respective timestamps indicated by a difference time into an elapsed time. The subsequent processes are the same as in Embodiments 1 and 2.

For example, specifically, the difference time indicated by the first time information item of a first trace packet x2 is “2” (LTS=2). In addition, here, the elapsed time of a first trace packet x1 having an order immediately preceding the first trace packet x2 is “10” (see Local TimeStamp1 “10”). As such, in the example in FIG. 6, the first time information conversion unit 120 converts, for example, the time information item “2” of the first trace packet x2 in FIG. 6 to an elapsed time “12” (10+2=12) as indicated in the first source stream 211B in the middle stage in FIG. 6.

It should be noted that the difference time is, for example, a time obtained by deducting, from the elapsed time of the trace packet (the trace packet of the difference time), the elapsed time of the trace packet immediately preceding the trace packet.

Furthermore, the elapsed time may be, for example, the difference time from an operation start time at which the LSI (the LSI 1 (FIG. 1), the LSI 1A (FIG. 2), the LSI 1C (FIG. 3)) starts operating up to the time of the trace packet of such elapsed time. Furthermore, the elapsed time may be a time starting from a starting time of the stream including the trace packet of such elapsed time, such as a time of the first trace packet of the stream, up to the time of such trace packet.

### Embodiment 4

FIG. 3 is a diagram showing a configuration of an LSI 1C in Embodiment 4.

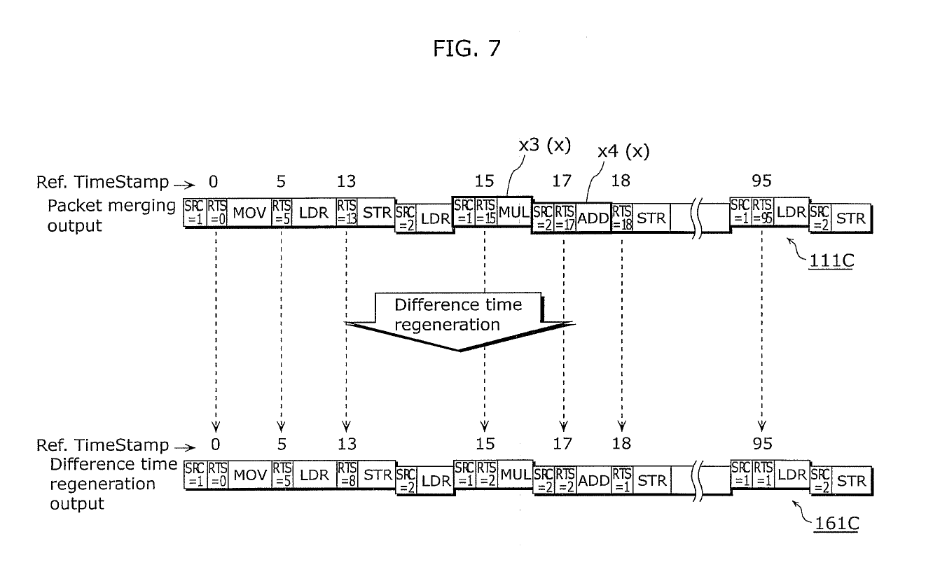

In addition, in the present embodiment, the time information items in the output of packet-merging (trace stream 111C in FIG. 7) are converted again to difference times by a difference time regeneration unit 160 (FIG. 3). FIG. 3 shows the configuration (LSI 1C) for re-converting the time information item of a packet into the difference time, in the output of the packet-merging.

In the LSI 1C, the time information item (elapsed time) of a packet outputted the last time around by the packet merging unit 110 is held by a final timestamp holding unit 170 (FIG. 3). Then, the difference (difference time) between the held time information item and the time information item of a packet currently outputted by the packet merging unit 110 is calculated by the difference time regeneration unit 160 (FIG. 3). With this, a packet merging output (trace stream 161C in FIG. 7 and trace stream 161 in FIG. 3) in which the time information item has been converted to the difference time is obtained.

FIG. 7 is a diagram showing two streams in Embodiment 4.

FIG. 7 shows an example in which the time information items of the packet merging output are converted into difference times through the configuration in FIG. 3. The times indicated by “RTS=” are elapsed times in the illustration in the top stage in FIG. 7 (the trace stream 111C), whereas, in the illustration in the bottom stage (the trace stream 161C), the times are difference times obtained through processing by the difference time regeneration unit 160.

FIG. 8 is a diagram showing four streams in the case where part of packets are lost.

In addition, FIG. 8 shows that, even when part of the packets (packet x5 and packet x6 in FIG. 8) are lost, the elapsed times are held and the temporal correlation between the trace data sources can be obtained. FIG. 8 shows that, in the trace information items after time information conversion, the “MUL” packet x5 at a time 15 of the first trace data source 210 (FIG. 3) cannot be inputted due to a FIFO overflow in the trace buffer or was not selected due to having a low priority level. Furthermore, FIG. 8 shows that the “ADD” packet x6 at a time 17 of the first trace data source 310 cannot be inputted due to a FIFO overflow in the trace buffer or was not selected due to having a low priority level.

Even in such a case, the elapsed time (RTS=18) of the packet x7 (FIG. 8) of a “STR” command at a time 18 is not lost, and thus the subsequent time information item is not lost. Furthermore, there is also no problem with regard to the regeneration of the difference time. Therefore, in the trace information items that can be obtained in the end (the second trace stream 161C), the time information items of the respective packets subsequent to the packet x5 and the packet x6 are not lost, and the temporal correlation between the trace data sources can be obtained.

In this manner, it is possible to construct a data processing device (LSI 1, LSI 1A, LSI 1C) which includes: a first trace data source (first trace data source 210); a first time information conversion unit (first time information conversion unit 120) configured to convert, into a time information item of a reference time, each of a plurality of time information items (first time information) that accompanies a corresponding one of a plurality of trace packets (first trace packet 211) from the first trace data source; a second trace data source (second trace data source 310); a second time information conversion unit (second time information conversion unit 130) configured to convert, into a time information item of a reference time, each of a plurality of time information items (second time information) that accompanies a corresponding one of a plurality of trace packets (second trace packet 311) from the second trace data source; and a packet merging unit (packet merging unit 110) configured to receive the trace packets having the corresponding time information item converted by the first time information conversion unit (first converted trace packet 121) and the trace packets having the corresponding time information item converted by the second time information conversion unit (second converted trace packet 131), to select the trace packet having an earliest one of the time information items and output (reconcile and output) the selected trace packet, and to remove a redundant time information item (for example, one of the time information of the reference time (RTS=13) that is third from the left in the first converted trace stream 121s in FIG. 4 and the time information of the reference time (RTS=13) that is left-most in the second converted trace stream 131s in FIG. 4) among the time information items of the trace packets (for example, between the trace packet that is third from the left in the first converted trace stream 121s in FIG. 4 and the trace packet that is left-most in the second converted trace stream 131s in FIG. 4).

It should be noted that, here, the packet merging unit, for example, selects the trace packet having the time information item whose order is a predetermined order (the earliest order), among all the time information items of the respective trace packets for which the time information has been converted by the first time information conversion unit and the time information items of the respective trace packets for which the time information has been converted by the second time information conversion unit.

In addition, the data processing apparatus (LSI 1A in FIG. 2, and LSI 1C in FIG. 3) further includes a synchronization packet request unit (synchronization packet request unit 400) configured to output a synchronization packet request to each of the first and second trace data sources, wherein the packet merging unit is configured to: select the trace packet having the earliest one of the time information items based on two synchronization packets (see synchronization packets y1 and y2 in FIG. 5), and output the selected trace packet, the two synchronization packets consisting of (i) a synchronization packet outputted from the first trace data source in response to the synchronization packet request outputted to the first trace data source and (ii) a synchronization packet outputted from the second trace data source in response to the synchronization packet request outputted to the second trace data source; and avoid outputting the synchronization packets, out of the trace packets and the synchronization packets.

In addition, in the data processing device, each of the time information items is an elapsed time (see time information items of the first source stream 211s in FIG. 4, and so on) measured by the corresponding one of the first and second trace data sources according to a clock provided to the corresponding one of the first and second trace data sources, and each of the first time information conversion unit and the second time information conversion unit is configured to convert, into a time information item of a single reference time (see time information items of the reference times of the first converted trace stream 121s in FIG. 4, and so on), a time information item of an elapsed time from the corresponding one of the first and second trace data sources.

It should be noted that “single” in “single reference time” means that the time information items in any trace data source are time information items of the reference time, among plural types of times including the reference time.

In addition, in the data processing device, each of the time information items is a difference time (see time information items of the first source stream 211B in the top stage in FIG. 6, and so on) from a time at which a last trace-related event occurred (processing time recorded at the last trace packet) up to a time at which a current event occurs at the corresponding one of the first and second trace data sources from which the time information item is generated, the difference time being measured by the corresponding one of the first and second trace data sources according to a clock (number of clocks) provided to the corresponding one of the first and second trace data sources, and each of the first time information conversion unit and the second time information conversion unit is configured to add up, to an elapsed time, a time information item of a difference time from the corresponding one of the first and second trace data sources (see time information items of the first source stream 211B in the middle stage in FIG. 6, and so on), and to convert the added-up elapsed time into a time information item of a single reference time (see the time information items of the first converted trace stream 121B in the bottom stage in FIG. 6, and so on).

It should be noted that adding-up a time information item of the difference time to an elapsed time means calculating the elapsed time up to the present by adding the one or more past difference times and the current difference time.

In addition, the data processing device (LSI 1C in FIG. 3) further includes: a final timestamp holding unit (final timestamp holding unit 170) configured to hold a time information item (see first trace packet x3 in FIG. 7) accompanying a previous trace packet (last trace packet) which is a trace packet last outputted by the packet merging unit, among the trace packets; and a difference time generation unit (difference time generation unit 160) configured to calculate a time difference (RTS=2) between the previous trace packet (first trace packet x3) and a current trace packet (see first trace packet x4 in FIG. 4) currently outputted among the trace packets, based on the time information item (for example, RTS=15 of the first trace packet x3 in FIG. 7) held by the final timestamp holding unit and a time information item (RTS=17) of the current trace packet (first trace packet x4).

In this manner, it is possible to obtain the correlation between the time information items of different trace data sources, while avoiding the negative effects caused by the outputting of even a reference timestamp in addition to local time information. It should be noted that correlation means, for example, identifying the difference in time obtained by subtracting the time of one time information item from the time of another time information item. If the first time information item and the second time information item do not include other information such as time difference information of a time difference between the first time and the second time, or the aforementioned reference timestamp. On the other hand, the time information item of the reference time that is converted from the first time information by the first time information conversion unit 120 and the time information item of the reference time that is converted from the second time information are both time information items of the reference time; there is no time difference, and a correlation can be obtained with only such information.

In this manner, by converting the time information item included in a trace information item from the trace data source into an elapsed time of the reference time, it is possible to suppress the outputting of plural types of time information items (time information items according to a local clock, a reference timestamp from a reference timestamp generator), and thus reduce overhead. In addition, by converting the time information item after the merge output into the difference time again, overhead can be further reduced (see FIG. 7, and so on). Furthermore, even when part of the packets is lost (see FIG. 8, and so on), the elapsed time information item is not lost and thus the temporal correlation can be obtained.

In this manner, the parallel processing LSI in the embodiments (the LSI 1, the LSI 1A, and the LSI 1C, and so on) includes plural processing units (the first processor core 200 and the second processor core 300), plural generation units (the first trace data source 210 and the second trace data source 310), and plural conversion units (the first time information conversion unit 120 and the second time information conversion unit 130).

Each of the processing units executes information processing in parallel with the information processing executed by another processing unit. For of the processing units, an event occurs in the information processing of such processing unit.

Each of the generation units generates a time information item for specifying a time (first time, second time) of the occurrence of the event of the processing unit corresponding to such generation unit.

Here, the time of a time information item generated by each of the generation units in each reference time is different from the time of a time information item generated by another generation unit in a reference time that is the same as such reference time. Specifically, for example, the time for each of the generation unit has a time difference with respect to the time for another generation unit. Furthermore, for example, the advancement speed of the time for each of the generation units is different from the advancement speed of the time for another generation unit. It should be noted that, here, the reference time may be a third time that is different from the times of any of the generation units, and may be a time of any one of the generation units.

In addition, each of the conversion units converts the time information item generated by the generation unit corresponding to the conversion unit, into a time information item of the reference time corresponding to the time indicated by such generated time information item.

It should be noted that each of the conversion units may hold, for example, correspondence data identifying the correspondence relationship among the respective times, such as correspondence data identifying the time difference between the time of a corresponding generation unit and the reference time. In addition, each of the conversion units may convert the time of the corresponding generation unit to the reference time that is associated with such time, in the held correspondence data.

With this, the time information item after conversion, which is generated by each of the generation units, indicates the reference time of the event of the processing unit corresponding to the generation unit. Here, all the indicated times are time information items of reference times. As such, the reference time of an event of one of the processing units and the reference time of the event of another processing unit are indicated, and thus the relative times between these events is identified.

This configuration enables correct and simple identification of relative time even when there is a time difference or a difference in time-advancement speed between two processors.

In addition, in this configuration, conversion of time information items is performed before hand by a parallel processing LSI. With this, the relative times is correctly identified even when unnecessary data such as the above-described correspondence data is not transmitted by the parallel processing LSI to the outside of the parallel processing LSI. Accordingly, the amount of transmission can be reduced.

Furthermore, unnecessary processing, such as conversion to reference time, outside the parallel processing LSI can be made unnecessary, and thus the relative times can be identified with less processing.

In addition, since a time information item having a time difference is sufficient as the time information item to be generated by each of the generation units, the configuration of the respective generation units can be simplified.

It should be noted that the parallel processing LSI may include a stream generation unit (the packet merging unit 110) which generates a stream (the trace stream 111s). Here, the generated stream includes the time information item after conversion by the respective conversion units, and the order in which the respective time information items are included in the stream is the same order as the order of the reference time indicated by such time information item, among the reference times indicated by the time information items that are included.

The stream generation unit may select the next time information item which is included in the stream next to the immediately preceding time information item, from among the time information items converted by the plural conversion units. Here, the selected time information item is a time information item indicating the reference time whose order is next to the order of the reference time indicated by the immediately preceding time information item.

It should be noted that the parallel processing LSI may include, for a value N which is equal to or greater than 3, N processing units, N generation units, and N conversion units.

It should be noted that the present invention is not limited to the above-described embodiments. Various modifications to the present embodiments that can be conceived by those skilled in the art, and forms configured by combining constituent elements in different embodiments without departing from the teachings of the present invention are included in the scope of the present invention.

### INDUSTRIAL APPLICABILITY

The data processing device according to the present invention is useful in the performance of analysis in which the time correlation of operations of plural cores is obtained in a system having plural cores. It should be noted that although, in the embodiments, the trace data source is a processor core, it may be a bus transaction monitor function or a hardware engine internal status monitor function.

What is claimed is:

1. A data processing device comprising:
a first trace data source;
a first time information conversion unit configured to convert, into a time information item of a reference time, each of a plurality of time information items that accompanies a corresponding one of a plurality of trace packets from said first trace data source;
a second trace data source;
a second time information conversion unit configured to convert, into a time information item of a reference time, each of a plurality of time information items that accompanies a corresponding one of a plurality of trace packets from said second trace data source; and
a packet merging unit configured to receive the trace packets having the corresponding time information item converted by said first time information conversion unit and the trace packets having the corresponding time information item converted by said second time information conversion unit, to select and output the trace packet having an earliest one of the time information items, and to remove a redundant time information item among the time information items of the trace packets.

2. The data processing apparatus according to claim 1, further comprising
a synchronization packet request unit configured to output a synchronization packet request to each of said first and second trace data sources,
wherein said packet merging unit is configured to:
select the trace packet having the earliest one of the time information items based on two synchronization packets, and output the selected trace packet, the two synchronization packets consisting of (i) a synchronization packet outputted from said first trace data source in response to the synchronization packet request outputted to said first trace data source and (ii) a synchronization packet outputted from said second trace data source in response to the synchronization packet request outputted to said second trace data source; and
avoid outputting the synchronization packets, out of the trace packets and the synchronization packets.

3. The data processing device according to claim 1,
wherein each of the time information items generated by said first and second trace data sources is an elapsed time measured by the corresponding one of said first and second trace data sources according to a clock provided to the corresponding one of said first and second trace data sources, and
each of said first time information conversion unit and said second time information conversion unit is configured to convert, into a time information item of a single reference time, a time information item of an elapsed time from the corresponding one of said first and second trace data sources.

4. The data processing device according to claim 1,
wherein each of the time information items generated by said first and second trace data sources is a difference time from a time at which a last trace-related event occurred up to a time at which a current event occurs at the corresponding one of said first and second trace data sources, the difference time being measured by the corresponding one of said first and second trace data sources according to a clock provided to the corresponding one of said first and second trace data sources, and
each of said first time information conversion unit and said second time information conversion unit is configured to add up, to an elapsed time, a time information item of a difference time from the corresponding one of said first and second trace data sources, and to convert the added-up elapsed time into a time information item of a single reference time.

5. The data processing device according to claim 1, further comprising:
a final timestamp holding unit configured to hold a time information item accompanying a previous trace packet which is a trace packet last outputted by said packet merging unit, among the trace packets; and
a difference time generation unit configured to calculate a time difference between the previous trace packet and a current trace packet currently outputted among the trace packets, based on the time information item held by said final timestamp holding unit and a time information item of the current trace packet.

6. A data processing method, comprising:
converting, into a time information item of a reference time, each of a plurality of time information items that accompanies a corresponding one of a plurality of trace packets from a first trace data source;
converting, into a time information item of a reference time, each of a plurality of time information items that accompanies a corresponding one of a plurality of trace packets from a second trace data source; and
receiving (i) the trace packets having the corresponding time information item converted in said converting of time information of trace packets from a first trace data source and (ii) the trace packets having the corresponding time information item converted in said converting of time information of trace packets from a second trace data source, selecting and outputting the trace packet having an earliest one of the time information items, and removing a redundant time information item among the time information items of the trace packets.

7. The data processing method according to claim 6, further comprising
outputting a synchronization packet request to each of the first and second trace data sources,
wherein in said receiving:
the trace packet having the earliest one of the time information items based on two synchronization packets is selected based on two synchronization packets, and the selected trace packet is outputted, the two synchronization packets consisting of (i) a synchronization packet outputted from the first trace data source in response to the synchronization packet request outputted to the first trace data source and (ii) a synchronization packet outputted from the second trace data source in response to the synchronization packet request outputted to said second trace data source; and
out of the trace packets and the synchronization packets, the synchronization packets are not outputted.

8. The data processing method according to claim 6,
each of the time information items generated by the first and second trace data sources is an elapsed time measured by the corresponding one of the first and second trace data sources according to a clock provided to the corresponding one of the first and second trace data sources, and
in each of said converting of time information of trace packets from a first trace data source and said converting of time information of trace packets from a second trace data source, a time information item of an elapsed time from the corresponding one of the first and second trace data sources, is converted into a time information item of a single reference time.

9. The data processing method according to claim 6,
wherein each of the time information items generated by the first and second trace data sources is a difference time from a time at which a last trace-related event occurred up to a time at which a current event occurs at the corresponding one of the first and second trace data sources, the time difference being measured by the corresponding one of the first and second trace data sources according to a clock provided to the corresponding one of the first and second trace data sources, and
in each of said converting of time information of trace packets from a first trace data source and said converting of time information of trace packets from a second trace data source, a time information item of a difference time from the corresponding one of the first and second trace data sources is added up to an elapsed time, and the added-up elapsed time is converted into a time information item of a single reference time.

10. The data processing method according to claim 6, further comprising:
holding a time information item accompanying a previous trace packet which is a trace packet last outputted in said receiving, among the trace packets; and
calculating a time difference between the previous trace packet and a current trace packet currently outputted among the trace packets, based on the time information item held in said holding and a time information item of the current trace packet.
